(19) United States
(12) Patent Application Publication
(10) Pub. No.: US 2018/0351952 A1
(43) Pub. Date: Dec. 6, 2018

(54) SYSTEM AND METHOD FOR SECURE MANAGEMENT OF NETWORK DEVICES

(71) Applicant: Schlumberger Technology Corporation, Sugar Land, TX (US)

(72) Inventors: Juan Jose ROJAS, Katy, TX (US); Shunfeng ZHENG, Katy, TX (US)

(21) Appl. No.: 15/612,773

(22) Filed: Jun. 2, 2017

(51) Int. Cl. H04L 29/06; G05B 19/042; G05B 19/05; E21B 41/00; E21B 44/00

(52) U.S. Cl. CPC H04L 63/10; H04L 63/162; H04L 63/083; G05B 2219/45129; G05B 19/056; E21B 41/0092; E21B 44/00; G05B 19/042

(57) ABSTRACT

The method may include obtaining, at a network element on a user network and from a user device, a request to access a programmable logic controller (PLC) located in a drilling management network. The method may further include determining, at the network element, whether the user device is authorized for accessing the PLC based at least in part on user access credentials associated with the user device. The method may further include establishing, in response to determining that the user device is authorized, a virtual connection between the user network and the drilling management network. The method may further include terminating the virtual connection.

### BACKGROUND

Various network devices may be disposed throughout a drilling rig in order to control various operations on the drilling rig. These network devices may control drilling equipment, monitor the performance of the drilling rig, and/or perform various maintenance operations with respect to the drilling rig. Accordingly, various problems exist in regard to effective enforcement of security protocols with respect such network devices.

### SUMMARY

In general, in one aspect, the invention relates to a method. The method includes obtaining, at a network element on a user network and from a user device, a request to access a programmable logic controller (PLC) located in a drilling management network. The method further includes determining, at the network element, whether the user device is authorized for accessing the PLC based at least in part on user access credentials associated with the user device. The method further includes establishing, in response to determining that the user device is authorized, a virtual connection between the user network and the drilling management network. The method further includes terminating the virtual connection.

In general, in one aspect, the invention relates to a system. The system includes a drilling management network that includes a programmable logic controller (PLC). The system further includes a user network coupled to the drilling management network. The user network includes various network elements. The system further includes a virtual connection controller operating on a network element of the network elements. The virtual connection controller obtains, from a user device, a request to access the PLC. The virtual connection controller determines whether the user device is authorized for accessing the PLC based on user access credentials associated with the user device. The virtual connection controller establishes, in response to determining that the user device is authorized, a virtual connection between the user network and the drilling management network. The virtual connection controller terminates the virtual connection.

In general, in one aspect, the invention relates to a non-transitory computer readable medium (CRM) storing instructions. The instructions include functionality for obtaining, at a network element on a user network and from a user device, a request to access a programmable logic controller (PLC) located in a drilling management network. The instructions further include functionality for determining, at the network element, whether the user device is authorized for accessing the PLC based on user access credentials associated with the user device. The instructions further include functionality for establishing, in response to determining that the user device is authorized, a virtual connection between the user network and the drilling management network. The instructions further include functionality for terminating the virtual connection.

Other aspects of the disclosure will be apparent from the following description and the appended claims.

### BRIEF DESCRIPTION OF DRAWINGS

FIGS. 1 and 2 show systems in accordance with one or more embodiments.

FIG. 3 shows a flowchart in accordance with one or more embodiments.

FIG. 4 shows an example in accordance with one or more embodiments.

FIG. 5 shows a flowchart in accordance with one or more embodiments.

FIGS. 6.1 and 6.2 shows an example in accordance with one or more embodiments.

FIGS. 7.1 and 7.2 show a computing system in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include a system and various methods for accessing control systems on a drilling management network. In particular, one or more embodiments are directed to a method that includes obtaining a request to access one or more control systems including one or more programmable logic controllers (PLCs) within the drilling management network. Specifically, a drilling management network may include a network disposed around a drilling rig that is closed to outside network connections until connecting devices are authenticated. In one or more embodiments, after authentication, a virtual connection is established for a temporary period of time between the drilling management network and a user network. While the virtual connection is online, network traffic may flow outside and into the drilling management network. Upon terminating the virtual connection, the drilling management network may return to being a closed network that is protected from various possible security breaches. Likewise, such temporary virtual connections may enforce security measures to both local users and/or remote users that log into the user network over the Internet. Moreover, this system may provide automated control over when and to which parts of the drilling management network are accessed by different users.

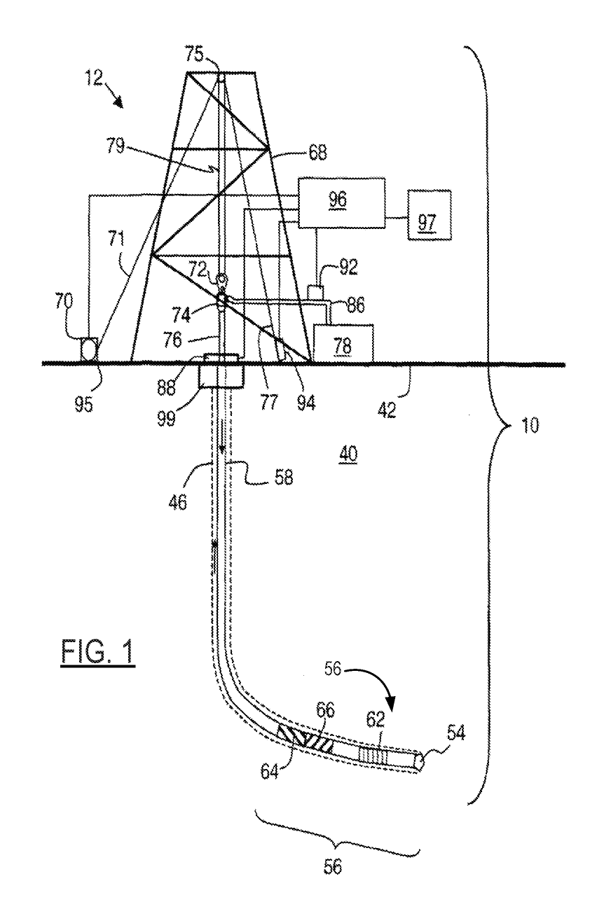

FIG. 1 shows a block diagram of a system in accordance with one or more embodiments. FIG. 1 shows a drilling system (10) according to one or more embodiments. Drill string (58) is shown within borehole (46). Borehole (46) may be located in the earth (40) having a surface (42). Borehole (46) is shown being cut by the action of drill bit (54). Drill bit (54) may be disposed at the far end of the bottom hole assembly (56) that is attached to and forms the lower portion of drill string (58). Bottom hole assembly (56) may include a number of devices including various subassemblies. Measurement-while-drilling (MWD) subassemblies may be included in subassemblies (62). Examples of MWD measurements may include direction, inclination, survey data, downhole pressure (inside the drill pipe, and/or outside and/or annular pressure), resistivity, density, and porosity. Subassemblies (62) may also include a subassembly for measuring torque and weight on the drill bit (54). The signals from the subassemblies (62) may be processed in a processor (66). After processing, the information from processor (66) may be communicated to pulser assembly (64). Pulser assembly (64) may convert the information from the processor (66) into pressure pulses in the drilling fluid. The pressure pulses may be generated in a particular pattern which represents the data from the subassemblies (62). The pressure pulses may travel upwards though the drilling fluid in the central opening in the drill string and towards the surface system. The subassemblies in the bottom hole assembly (56) may further include a turbine or motor for providing power for rotating and steering drill bit (54).

The drilling rig (12) may include a derrick (68) and hoisting system, a rotating system, and/or a mud circulation system, for example. The hoisting system may suspend the drill string (58) and may include draw works (70), fast line (71), crown block (75), drilling line (79), traveling block and hook (72), swivel (74), and/or deadline (77). The rotating system may include a kelly (76), a rotary table (88), and/or engines (not shown). The rotating system may impart a rotational force on the drill string (58). Likewise, the embodiments shown in FIG. 1 may be applicable to top drive drilling arrangements as well. Although the drilling system (10) is shown being on land, those of skill in the art will recognize that the described embodiments are equally applicable to marine environments as well.

The mud circulation system may pump drilling fluid down an opening in the drill string. The drilling fluid may be called mud, which may be a mixture of water and/or diesel fuel, special clays, and/or other chemicals. The mud may be stored in mud pit (78). The mud may be drawn into mud pumps (not shown), which may pump the mud though stand pipe (86) and into the kelly (76) through swivel (74), which may include a rotating seal. Likewise, the described technologies may also be applicable to underbalanced drilling If underbalanced drilling is used, at some point prior to entering the drill string, gas may be introduced into the mud using an injection system (not shown).

The mud may pass through drill string (58) and through drill bit (54). As the teeth of the drill bit (54) grind and gouge the earth formation into cuttings, the mud may be ejected out of openings or nozzles in the drill bit (54). These jets of mud may lift the cuttings off the bottom of the hole and away from the drill bit (54), and up towards the surface in the annular space between drill string (58) and the wall of borehole (46).

At the surface, the mud and cuttings may leave the well through a side outlet in blowout preventer (99) and through mud return line (not shown). Blowout preventer (99) comprises a pressure control device and a rotary seal. The mud return line may feed the mud into one or more separator (not shown) which may separate the mud from the cuttings. From the separator, the mud may be returned to mud pit (78) for storage and re-use.

Various sensors may be placed on the drilling rig (12) to take measurements of the drilling equipment. In particular, a hookload may be measured by hookload sensor (94) mounted on deadline (77), block position and the related block velocity may be measured by a block sensor (95) which may be part of the draw works (70). Surface torque may be measured by a sensor on the rotary table (88). Standpipe pressure may be measured by pressure sensor (92), located on standpipe (86). Signals from these measurements may be communicated to a surface processor (96) or other network elements (not shown) disposed around the drilling rig (12). In addition, mud pulses traveling up the drillstring may be detected by pressure sensor (92). For example, pressure sensor (92) may include a transducer that converts the mud pressure into electronic signals. The pressure sensor (92) may be connected to surface processor (96) that converts the signal from the pressure signal into digital form, stores and demodulates the digital signal into useable MWD data. According to various embodiments described above, surface processor (96) may be programmed to automatically detect one or more rig states based on the various input channels described. Processor (96) may be programmed, for example, to carry out an automated event detection as described above. Processor (96) may transmit a particular rig state and/or event detection information to user interface system (97) which may be designed to warn various drilling personnel of events occurring on the rig and/or suggest activity to the drilling personnel to avoid specific events.

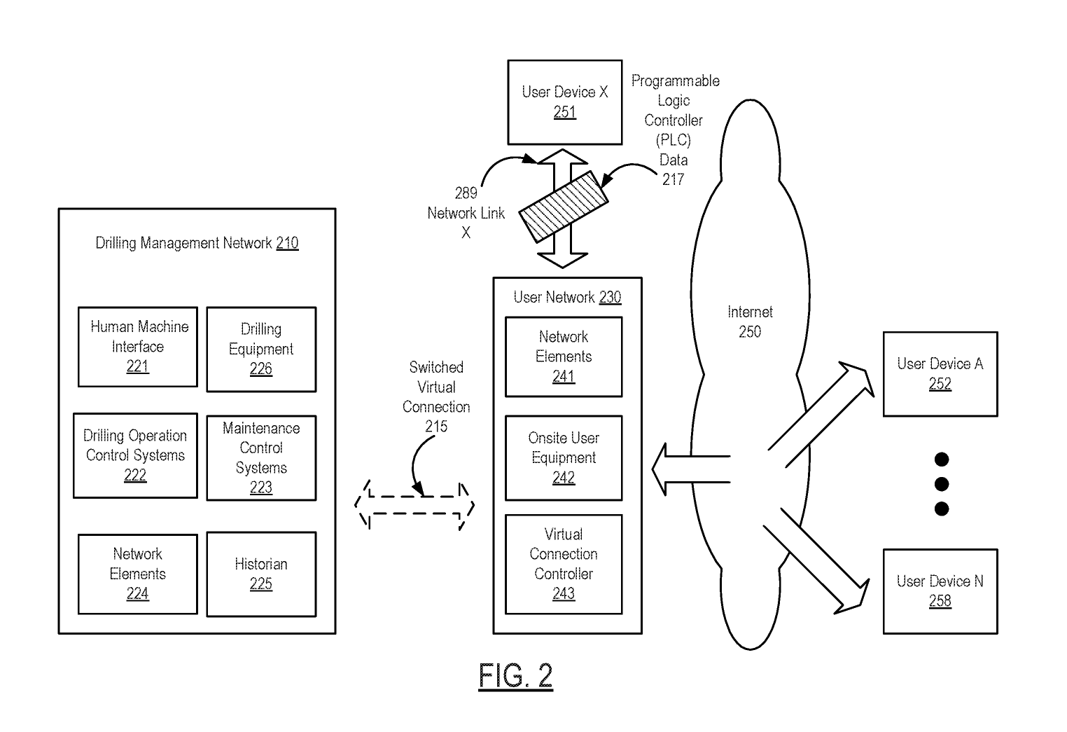

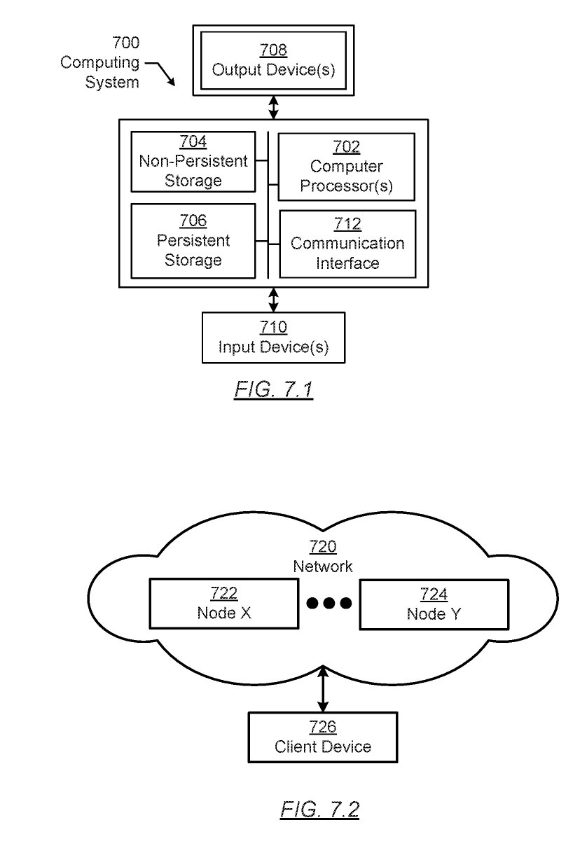

FIG. 2 shows a block diagram of a system in accordance with one or more embodiments. As shown in FIG. 2, a drilling management network (210) may include a human machine interface (HMI) (e.g., HMI (221)), a historian (e.g., historian (225)), and various network elements (e.g., network elements (224)). A human machine interface may be hardware and/or software coupled to the drilling management network (210), and which includes functionality for presenting data and/or receiving inputs from a user regarding various drilling operations and/or maintenance operations performed within the drilling management network (210). For example, a human machine interface may include software to provide a graphical user interface (GUI) for presenting data and/or receiving control commands for operating a drilling rig. A network element may refer to various hardware components within a network, such as switches, routers, hubs or any other logical entities for uniting one or more physical devices on the network. In particular, a network element, the human machine interface, and/or the historian may be a computing system similar to the computing system (700) described in FIGS. 7.1 and 7.2, and the accompanying description.

In one or more embodiments, the drilling management network (210) may include drilling equipment (e.g., drilling equipment (226)) such as the blowout preventer (99), the drilling rig (12), and other components described above in FIG. 1 and the accompanying description. The drilling management network (210) may further include various drilling operation control systems (e.g., drilling operation control systems (222)) and various maintenance control systems (e.g., maintenance control systems (223)). Drilling operation control systems and/or maintenance control systems may include, for example, programmable logic controllers (PLCs) that include hardware and/or software with functionality to control one or more processes performed by a drilling rig, including, but not limited to the components described in FIG. 1. Specifically, a programmable logic controller may control valve states, fluid levels, pipe pressures, warning alarms, and/or pressure releases throughout a drilling rig. In particular, a programmable logic controller may be a ruggedized computer system with functionality to withstand vibrations, extreme temperatures, wet conditions, and/or dusty conditions, for example, around a drilling rig.

Moreover, drilling operation control systems and/or maintenance control systems may refer to control systems that include multiple PLCs within the drilling management network (210). For example, a control system may include functionality to control operations within a system, assembly, and/or subassembly described above in FIG. 1 and the accompanying description. As such, one or more of the drilling operation control systems (222) may include functionality to monitor and/or perform various drilling processes with respect to the mud circulation system, the rotating system, a pipe handling system, and/or various other drilling activities described with respect to FIG. 1 and the accompanying description. Likewise, one or more of the maintenance control systems (223) may include functionality to monitor and/or perform various maintenance activities regarding drilling equipment located around a drilling rig. While drilling operation control systems and maintenance control systems are shown as separate devices in FIG. 2, in one or more embodiments, a programmable logic controller and other drilling equipment (226) on a drilling rig may be used in a drilling operation control system and a maintenance control system at the same time.

In one or more embodiments, the drilling management network (210) is coupled to a user network (e.g., user network (230)). In particular, the user network (230) may include various network elements (e.g., network elements (241)) and/or onsite user equipment (e.g., onsite user equipment (242)). For example, onsite user equipment may include phone systems, personal computers for various users, printers, application servers, and/or file servers located around a drilling rig. Likewise, the drilling management network (210) and the user network (230) may be connected by one or more physical links. In one or more embodiments, for example, the user network (210) shares one or more network elements with the drilling management network (210).

In one or more embodiments, the user network (230) include a virtual connection controller (243) that includes functionality to establish a virtual connection between the user network (230) and the drilling management network (210). The virtual connection may be, for example, a data link layer connection between two adjacent network elements, such as two network switches. In other embodiments, the virtual connection may be a point-to-point connection over multiple network nodes. Likewise, the virtual connection controller (243) may be a virtual machine (VM) or a physical network element located in the user network (230). For example, the virtual connection controller (243) may be a jump host or a network element that communicates with a jump host on the user network (230). In one or more embodiments, for example, the virtual connection controller (243) includes functionality to power on and/or power off a jump host that provides communication with devices on the drilling management network (210). Likewise, in some embodiments, the virtual connection controller (243) includes hardware and/or software distributed over multiple network elements in the user network (230) and the drilling management network (210). In one or more embodiments, for example, the virtual connection controller (243) is a jump host that includes functionality for managing security within the drilling management network (210). In particular, the drilling management network (210) may be a separate security zone from the user network (230).

In one or more embodiments, the drilling management network (210) transmits data over the virtual connection without a restriction on a data type and data source. As such, the virtual connection may control a data transmission between the drilling management network (210) and the user network (230).

In an idle state, the virtual connection controller (243) may be physically connected to the drilling management network (210) and isolated from any network communication with the network elements (224) in the drilling management network (210). In one or more embodiments, when the virtual connection controller (243) detects a request to access the drilling management network (210) from an authorized user or user device, the virtual connection controller (243) may implement various rules on a local firewall (not shown) to establish the virtual connection to the drilling management network (210). The implemented rules may allow user access to one or more approved software applications, specify which network ports may receive data over the virtual connection, and/or designate network protocols for using approved Internet Protocol (IP) Addresses across the virtual connection.

In one or more embodiments, the virtual connection controller (243) is disconnected from the drilling management network (210) while a drilling rig is performing drilling operations. Moreover, the virtual connection controller (243) may include functionality to power up a jump host and establish a virtual connection upon obtaining confirmation that the drilling rig is not performing drilling operations.

In one or more embodiments, for example, the virtual connection controller (243) includes functionality for operating a switched virtual connection (e.g., switched virtual connection (215)) disposed between the drilling management network (210) and the user network (230). For example, the switched virtual connection (215) may include hardware and/or software on the drilling management network (210) and the user network (230) for implementing a virtual connection. Thus, when the switched virtual connection (215) is “open”, no virtual connection may exist between the user network (230) and the drilling management network (210). When the switched virtual connection (215) is “closed”, the switched virtual connection (215) may form a temporary virtual circuit that provides transmission of network traffic, such as PLC data (e.g., PLC data (217), between the drilling management network (210) and the user network (230). PLC data may include sensor measurements, status updates, and/or information relating to drilling operations and/or maintenance operations performed on the drilling management network (210) that originates on the drilling management network (210). In particular, the default state of the switched virtual connection (215) may be where the drilling management network (210) is disconnected from the user network (230) until the virtual connection controller (243) detects an authorized user and/or user device requesting access.

Likewise, while a single switched virtual connection is shown in FIG. 2, multiple switched virtual connections may couple the drilling management network (210) and the user network (230). For example, multiple switched virtual connections may be implemented for redundancy purposes in case a fault occurs in a physical link within the switched virtual connection. Likewise, the drilling management network (210) may include two or more physically separate networks, and different virtual connections may be established in order to access different drilling operation control systems (222) and/or maintenance control systems (223). Moreover, other network links may exist between the drilling management network (210) and the user network (230) that are not shown in FIG. 2 and provide for transmission of PLC data outside the drilling management network (210).

In one or more embodiments, the drilling management network (210) is a closed network. For example, the drilling management network (210) may be a physical network or a virtual network where network communication is controlled between network nodes on the drilling management network (210) (e.g., network elements (224), drilling operation control systems (222), maintenance control systems (223)) and network nodes outside the drilling management network (210) (e.g., network nodes on the user network (230), such as network elements (241) and/or onsite user equipment (242)). In one or more embodiments, for example, while the drilling management network (210) and the user network (230) share one or more network elements, network nodes on the drilling management network (210) cannot communicate to various user devices (e.g., user device X (251)) until a virtual connection is established on the switched virtual connection (215).

Furthermore, the user network (230) may be an open network. In particular, network nodes on the user network (230) may obtain and/or transmit data outside the user network (230), for example, over the Internet (250). Where the drilling management network (210) may be limited to network communication between network nodes in the drilling management network (210), users on the user network (230) may establish a variety of different authorized network connections outside the user network (230), e.g., users may establish VoIP phone calls across the Internet (250), transmit email and/or access Internet from user devices on the user network (e.g., user device X (251)). Likewise, various user devices (e.g., user device A (252) and user device N (258)) may be coupled to the user network (230). User devices may include various computer systems that include functionality to connect to the user network (230), such as smartphones, laptops, personal computers, etc.

In one or more embodiments, the drilling management network (210) includes a distributed architecture. For example, the drilling management network (210) may include functionality to control drilling and/or maintenance operation around a drilling rig without a central controller. In another example, the drilling management network (210) may be a ring network where PLC data, control commands and other network traffic flows in a single direction or multiple directions around the ring network. In one or more embodiments, where a virtual connection is established to the user network (230), PLC data is transmitted in a single direction across the drilling management network (210) to the virtual connection controller (243) and/or one or more user devices.

While FIGS. 1 and 2 show various configurations of components, other configurations may be used without departing from the scope of the disclosure. For example, various components in FIGS. 1 and 2 may be combined to create a single component. As another example, the functionality performed by a single component may be performed by two or more components.

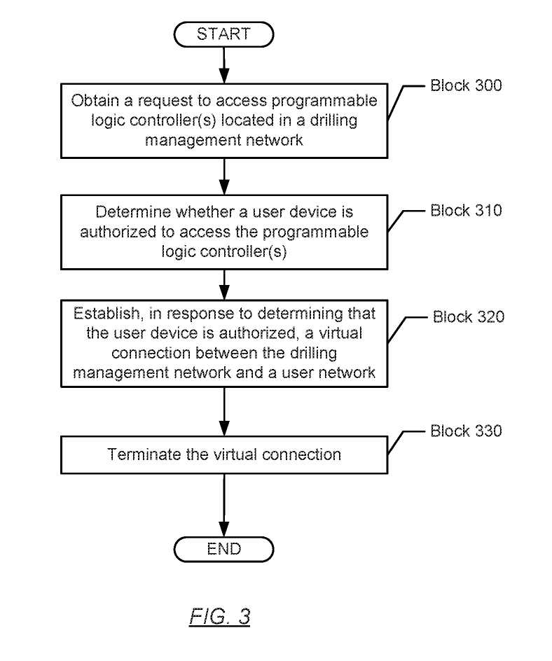

Turning to FIG. 3, FIG. 3 shows a flowchart in accordance with one or more embodiments. Specifically, FIG. 3 describes a method for accessing one or more control systems on a drilling management network. One or more blocks in FIG. 3 may be performed by one or more components (e.g., virtual connection controller (243)) as described in FIGS. 1 and/or 2. While the various blocks in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 300, a request is obtained to access one or more programmable logic controllers located in a drilling management network in accordance with one or more embodiments. For example, a user device may transmit a request to a virtual connection controller designated for controlling a switched virtual connection to the drilling management network. The user device may be connected locally on a user network coupled to the drilling management network or remotely connect to the virtual connection controller, e.g., over the Internet.

Moreover, the request may be a message that identifies the user device and/or the user attempting to access one or more of the PLCs in the drilling management network. For example, the request may include password information and/or other identification information that may be used by the virtual connection controller to determine if the user device is authorized. The request may also include information regarding which PLCs that the user device or user seeks to access. While Block 300 describes a request to access one or more PLCs, in one or more embodiments, the request is to access one or more drilling operation control systems and/or one or more maintenance control systems as described above in FIG. 2 and the accompanying description.

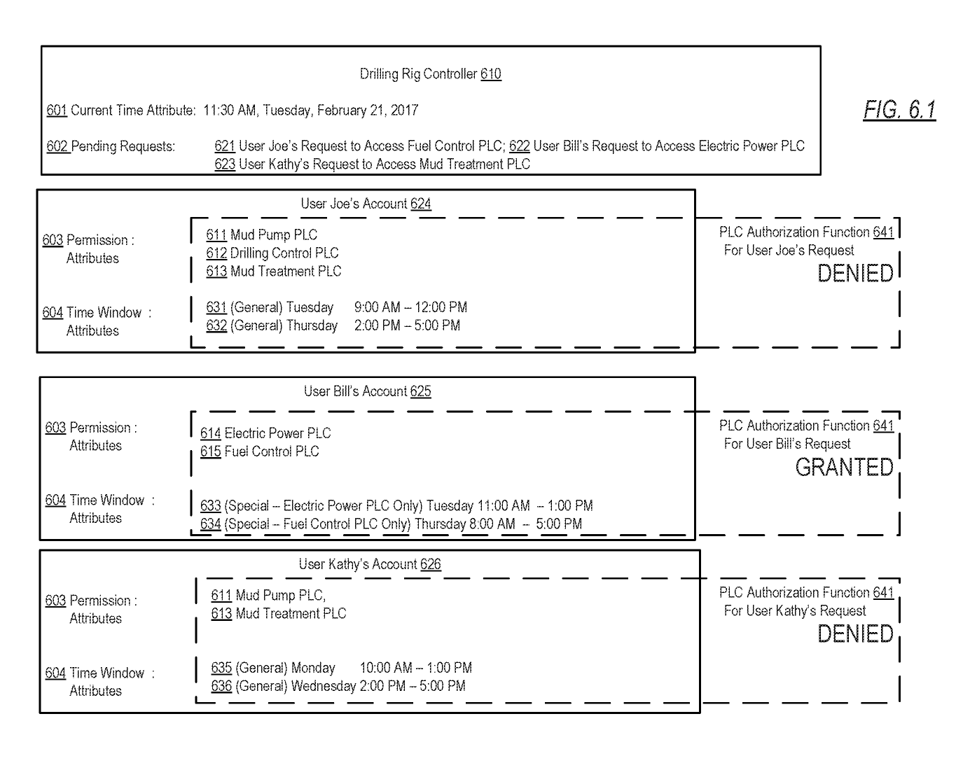

In one or more embodiments, a virtual connection controller implements a multi-factor authentication for accessing the drilling management network. For example, a user device may log into a user network with a username and password. Accordingly, after establishing a network connection to the user network, the virtual connection controller may request an additional password and/or identification to establish a virtual connection. For example, the additional password and/or identification information may be a personal identification number, a biometric identifier such as a fingerprint, personal information regarding the user requesting access, and/or a user device code transmitted independently to a user device. For more information on user device codes, see Block 540 in FIG. 5 and the accompanying description.

In Block 310, a determination is made whether a user device is authorized to access one or more programmable logic controllers in accordance with one or more embodiments. In response to obtaining the request in Block 300, for example, a network element and/or software application may determine whether the user device has permission to access a particular PLC. For example, a virtual connection controller may access a user account associated with a user device and/or a user operating the user device. The user account may include user credentials that designate which PLCs a user and/or user device may access. Furthermore, the user credentials may also specify one or more time windows when a user and/or user device may control a specific PLC and/or any PLCs. For more information on time windows, see Blocks 520, 525, and 530 below in FIG. 5 and the accompanying description. The user credentials may be manually entered into the user account by an administrator and/or automatically generated based on various information associated with a user and/or user device stored in the user account or elsewhere.

In Block 320, a virtual connection is established between a drilling management network and a user network in response to determining that a user device is authorized in accordance with one or more embodiments. If a determination is made that the user device is authorized to access a particular PLC, for example, a virtual connection controller may establish the virtual connection to the drilling management network. If a switched virtual connection exists between the drilling management network and the user network, the virtual connection controller may enable network communication across the switched virtual connection to establish the virtual connection. The switched virtual connection may be similar to switched virtual connection (215) described above in FIG. 2 and the accompanying description. On the other hand, if the determination is made that the user device is not authorized to access one or more of the PLCs and/or the user device is not authorized at the current time, the virtual connection may not be established in Block 320.

In one or more embodiments, a virtual connection controller is shut down and/or disconnected from a drilling management network. After a user is determined to be authorized to access the drilling management network in Block 310, the virtual connection controller may power up and establish the virtual connection to the drilling management network.

In Block 330, a virtual connection is terminated in accordance with one or more embodiments. In particular, a virtual connection controller or other software application may terminate the virtual connection established in Block 320. For example, a virtual connection controller may remove a data link layer connection between a drilling management network and a user network that returns the drilling management network into a closed state. Likewise, firewall settings may be set by a virtual connection controller to block network traffic from and to the drilling management network. In the case of a switched virtual connection, the virtual connection controller may set the switched virtual connection to be an open circuit. In one or more embodiments, for example, the virtual connection controller shuts down and disconnects after a determination is made to terminate the virtual connection.

In one or more embodiments, for example, a user and/or user device is designated a specific period of time when the virtual connection in Block 320 remains active. Once the virtual connection is established in Block 320, the virtual connection may automatically terminate after an hour or other specified period of time. In one or more embodiments, for example, the virtual connection is automatically terminated after an approved maintenance time period unless an extension is approved through one or more proper channels. Likewise, in another embodiment, a software application operating on a user network and/or the user device monitors whether a specific amount of time has elapsed since any user activity has been performed with respect to the virtual connection. For example, if the user device has not transmitted a control command and/or obtained any PLC data for a particular amount of time across the virtual connection from Block 320, a virtual connection controller may determine that a time-out of the user device has occurred and terminate the virtual connection accordingly.

In another embodiment, the user device may transmit a request to terminate the virtual connection, e.g., to a virtual connection controller. A user may decide that he or she is finished accessing one or more PLCs or control systems and send a command to the virtual connection controller to terminate the virtual connection. Accordingly, the user device may automatically transmit a request to terminate the virtual connection in response to the user logging out of a graphical user interface provided for accessing the one or more PLCs.

Furthermore, as described in FIG. 3 above and in FIG. 5 below, access may describe read and/or control access with respect to one or more network devices, such as PLCs, located on the drilling management network. However, in one or more embodiments, access is directed towards control commands being sent into a drilling management network. For example, one or more network links may exist between a drilling management network and a user network that provide for transmission of PLC data. In this case, the established virtual connection may be limited to transmission of control commands and/or other control data that is sent to change settings, parameters, and processes performed on the drilling management network. In some embodiments, for example, a user device may be able to monitor the drilling management network without establishing a virtual connection in Block 320. Here, the virtual connection may be established only when the user device seeks to adjust various settings on one or more PLCs and/or other network devices in the drilling management network.

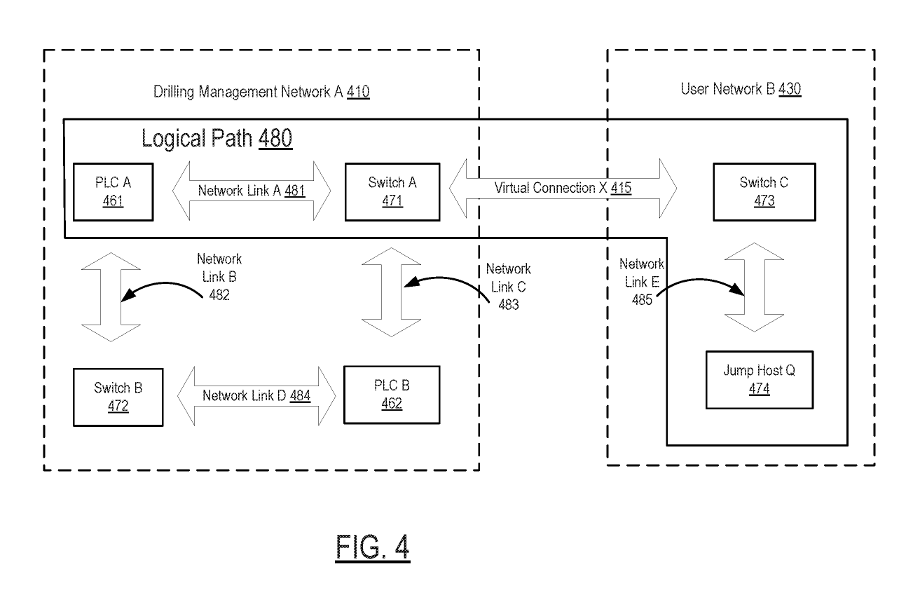

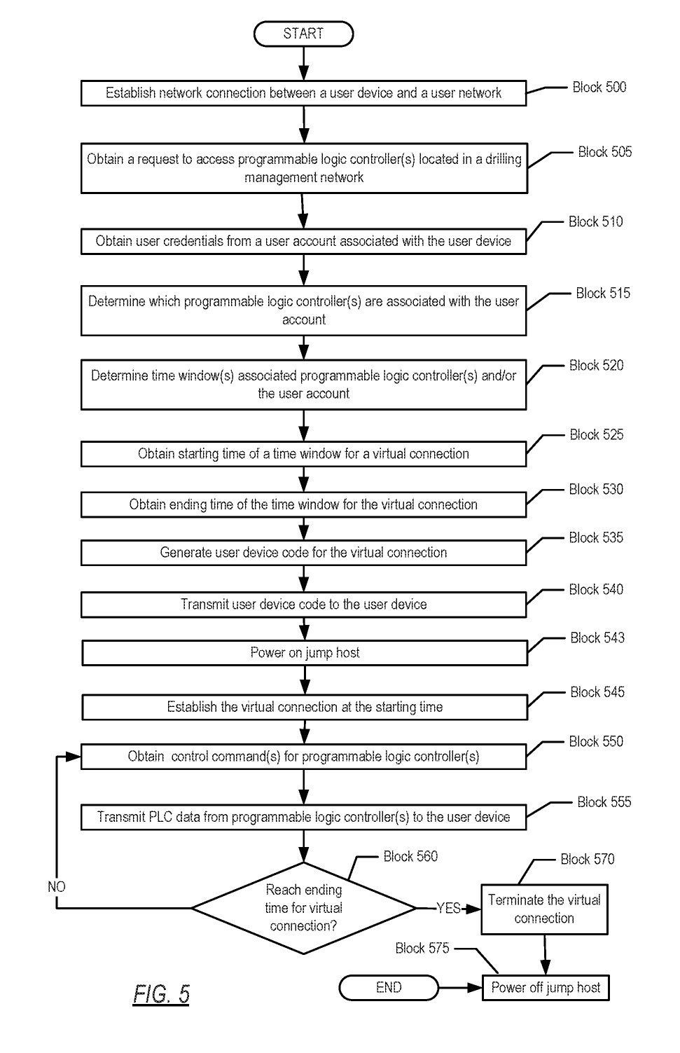

Turning to FIG. 4, FIG. 4 provides an example of an end-to-end connection from a network node on a drilling management network to a jump host. The following example is for explanatory purposes only and not intended to limit the scope of the disclosure. Turning to FIG. 4, FIG. 4 shows a logical path (480) that is established from a programmable logic controller (i.e., PLC A (461)) to jump host Q (474). As shown in FIG. 4, various network links (i.e., network link A (481), network link B (482), network link C (483), network link D (484), and network link E (485)) are formed between various network nodes in the drilling management network X (410) (e.g., PLC A (461), PLC B (462), switch A (471), switch B (472)) and user network B (430) (e.g., switch C (473), jump host Q (474)). Moreover, a virtual connection X (415) is established between switch A (471) on the drilling management network A (410) and switch C (473) on a user network B (430). Using the virtual connection X (415), a logical path (480) is formed between PLC A (461) and jump host Q (474) that enables the jump host Q (474) to obtain data from the PLC A (461) and/or transmitting data to PLC A (461). The logical path (480) may enable the jump host Q (474) to communicate with the PLC A (461), for example, by adjusting settings on the PLC A (461) using control commands. Likewise, the jump host Q (474) may obtain PLC data from the PLC A (461) that provides information on various drilling operations and/or maintenance tasks being performed on the drilling management network A (410). When the virtual connection X (415) terminates, the logical path (480) also terminates between PLC A (461) and the jump host Q (474).

In one or more embodiments, for example, a virtual connection between a drilling management network and a user network does not provide direct access to the drilling operation control systems and/or maintenance control systems to a user device (e.g., user device X (251)). In contrast to FIG. 4, in some embodiments, for example, the user device Z (451) may not communicate directly with PLC A (461) but via a virtual connection controller and/or other network intermediary. A logical path may exist over the virtual connection X (415) to the virtual connection controller. Based on control commands received at the virtual connection controller from the user device, the virtual connection controller may retransmit new control commands directly to a programmable logic controller or control system on the drilling management network. Likewise, the virtual connection controller may receive PLC data from a programmable logic controller or control system before retransmitting the PLC data to a user device.

Turning to FIG. 5, FIG. 5 shows a flowchart for generating a vulnerability map in accordance with one or more embodiments. Specifically, FIG. 5 describes a method for accessing one or more control systems on a drilling management network. One or more blocks in FIG. 5 may be performed by one or more components (e.g., virtual connection controller (243)) as described in FIGS. 1 and/or 2. While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 500, a network connection is established between a user device and a user network in accordance with one or more embodiments. In particular, a user device may remotely connect over the Internet to the user network. Likewise, the network connection may be established locally on the user network, e.g., connecting the user device to a switch located on a drilling rig. In regards to a remote network connection, the network connection may be established using a remote display protocol, such as a remote desktop protocol, to access a virtual connection controller on the user network. In one or more embodiments, the user device connects to a network element on a user network that can communication to a virtual connection controller and/or a jump host. For example, the user device may provide login information such as identification and/or password information to log into the user network. In one or more embodiments, the user network may be similar to the user network (230) described in FIG. 2 and the accompanying description.

In Block 505, a request is obtained to access one or more programmable logic controllers located in a drilling management network in accordance with one or more embodiments. Block 505 may be similar to Block 300 described in FIG. 3 and the accompanying description.

In Block 510, user credentials are obtained from a user account associated a user device in accordance with one or more embodiments. For example, various user accounts may be stored on a user network in a data storage device or in a remote storage location that is accessible by one or more software applications operating on the user network. In one or more embodiments, a virtual connection controller identifies the user device from Block 500 and matches the user device to a particular user account. For example, identification and/or password information from Block 500 may also be associated with a particular user account. On the other hand, user devices may be designated an additional unique identification that matches the user device to a particular user account.

In one or more embodiments, the user credentials include permission attributes. For example, permission attributes may designate one or more control systems and/or one or more programmable logic controllers on a drilling management network that a user and/or user device may access. In particular, different employees at the drilling management network may be assigned access based on their jobs and responsibilities. For example, a user whose job is to operate and maintain a mud pump may have permission attributes that designate access to a mud pump PLC and a mud treatment PLC. However, the user may not have permission attributes that provide access to a top drive PLC that controls drill string rotation. Accordingly, the permission attributes for the user may be described in the respective user account for the user.

In Block 515, a determination is made regarding which programmable logic controllers are associated with a user account in accordance with one or more embodiments. For example, the request from Block 505 may be a request to access to a specific PLC or control system in a drilling management network. A virtual connection controller may analyze the user credentials from Block 510 determine if any permission attributes match the specified PLC. On the other hand, if the request is a general request to access the drilling management network, a virtual controller may examine the permission attributes for any PLCs and/or control systems associated with a user and/or user device. If a user device is not authorized to access any programmable logic controllers at the current time on the drilling management network, the request from Block 505 may be ignored. Likewise, Block 515 may be similar to Block 310 described in FIG. 3 and the accompanying description.

In Block 520, a determination is made whether one or more time windows are associated with one or more programmable logic controllers and/or a user account in accordance with one or more embodiments. In one or more embodiments, for example, access to the drilling management network is time bounded. In particular, PLC and/or control system access may be granted to user devices at approved times. As such, in one or more embodiments, access to one or more PLCs and/or control systems is associated with one or more time windows. For example, a time window may specify a starting time and an ending time when a user device may access a specific PLC. Between the starting time and the ending time, a user device may obtain PLC data from the specific PLC and/or transmit one or more control commands to the specific PLC. Likewise, a time window may be designated for specific user and/or user device, e.g., to prevent access to a control system during a regularly scheduled maintenance operation.

In another embodiment, a time window may refer to a particular amount of time that a user device is allowed for accessing a specific PLC. For example, a virtual connection controller may record the amount of time that the user device accesses the specific PLC before the virtual connection be terminated. Accordingly, when a user device exceeds the amount of time designated for a time window, the virtual connection may be terminated. Thus, after expiration of a particular time window, a virtual connection controller may prevent a future virtual connection from being established until the time window is reset. For example, time windows may be reset weekly, monthly, or at other periodic time intervals for a user and/or user device.

In a further embodiment, for example, a user may be designated one or more general time windows for accessing a PLC or control system on the drilling management network. In a general time window, a virtual connection may be established where the user device can access any PLC or control system that the user device is otherwise authorized to access. On the other hand, in one or more embodiments, a user is designated a specific time window for a particular PLC or control system. In a specific time window, a virtual connection is established where the user device may access a specific PLC or control system associated with the specific time window. Moreover, a specific time window for a user device may overlap for a portion of time with another specific time window or without any overlap in time.

In one or more embodiments, the user credentials from Block 510 include time window attributes. Specifically, time window attributes may be data fields that provide information regarding starting times, ending times, particular days of the week, month, or year, and allotted amounts of time for various time windows assigned to a user and/or user device. Moreover, time window attributes may describe general time windows and specific time windows.

In Block 525, a starting time of a time window is obtained for a virtual connection in accordance with one or more embodiments. A virtual connection controller may extract various time window attributes from a user account to determine, for example, a starting time of a time window for a virtual connection to a drilling management. In particular, the starting time of the time window may be before or after the time that a request is received in Block 505. If the starting time of the time window is after the request, the virtual connection controller may notify a user device that the virtual connection may not be established until the starting time. If the starting time is before the request, a virtual connection controller may establish a virtual connection immediately.

In Block 530, an ending time of a time window is obtained for a virtual connection in accordance with one or more embodiments. Similar to Block 525, various time window attributes may be examined to determine the ending time of a time window. In one or more embodiments, a virtual connection controller notifies a user device regarding the amount of time that the virtual connection will be established, e.g., until the ending time of the current time window.

In Block 535, a user device code is generated for a virtual connection in accordance with one or more embodiments. In one or more embodiments, for example, upon determining that a user device is authorized to access the drilling management network, a virtual connection controller triggers a process to generate a time bounded set of virtual connection credentials. For example, the virtual connection credentials may include network and/or firewall configurations for communicating across a virtual connection. Moreover, in response to a virtual connection controller determining that a user device is authorized, the virtual connection credentials may include a user device code specifically generated for the user device. A user device code may be a pseudorandom or otherwise predetermined alphanumeric sequence that enables a user device to communicate with a PLC and/or control system on the drilling management network.

In one or more embodiments, for example, a user device code is configured to enable a user device to log into a control system application provided by a virtual connection controller. In particular, as the user device code may be different from the identification and/or password information used to establish the network connection in Block 500, the user device code may produce a multi-factor authentication for security purposes. For example, the user device code may be a temporary software token where the user device code is stored on the user network or user device. Once the virtual connection is terminated, such as when a time window expires, the user device code may no longer allow communication across any current or future virtual connections to the drilling management network. Thus, user device codes may be generated per authorized request and limited to one or more virtual connections.

In Block 540, a user device code is transmitted to a user device in accordance with one or more embodiments. In response to generating a user device code in Block 535, a virtual connection controller may transmit the user device code to the user device from Block 500. However, in one or more embodiments, the virtual connection controller acts as a network intermediary between the user device and control systems on the drilling management network. Thus, the virtual connection controller may store the user device code locally on a user network without transmitting the user device code to the user device.

In Block 543, a jump host is powered on in accordance with one or more embodiments. For example, the jump host may be the virtual connection controller or a separate device from the virtual connection controller. When the jump host is powered off, network communication may be prevented between a drilling management network and a user network that includes the jump host. The jump host may be powered off by a software application operating on the user network, for example.

In Block 545, a virtual connection is established at a starting time in accordance with one or more embodiments. In one or more embodiments, for example, the virtual connection is established in a similar manner as discussed in Block 320 in FIG. 3 and the accompanying description. The starting time may be the same starting time as discussed in Block 525 and the accompanying description. Likewise, the virtual connection may be established by a virtual connection controller. Moreover, in one or more embodiments, the virtual connection controller or other network application monitors network traffic across the virtual connection. For example, a virtual connection controller may record requests for particular types of PLC data from the drilling management network as well as any control commands transmitted to any PLCs or control systems on the drilling management network.

In one or more embodiments, for example, the virtual connection controller determines one or more access rights for the user device with respect to the virtual connection. For example, a user device may be granted read access and/or control access to one or more settings on a PLC or control system in the drilling management network. For example, access rights for a user device may be stored in the user account described in Block 510 along with time window attributes and permission attributes.

In Block 550, one or more control commands are obtained for one or more programmable logic controllers in accordance with one or more embodiments. A control command may be a message or instruction that causes a PLC or control system to perform a predetermined type of operation. For example, control commands may change one or more processes to be performed by a drilling operation control system and/or a maintenance control system. Moreover, control commands may adjust equipment settings and parameters with respect to the one or more processes. In one or more embodiments, for example, a drilling management network only obtains control commands from a user network and/or user device through the virtual connection established in Block 545. When the virtual connection is terminated, the user network and/or the user device may still obtain PLC data from the drilling management network but may be unable to modify settings and/or processes performed on the drilling management network.

In some embodiments, for example, a user device may transmit a control command to a virtual connection controller. Accordingly, the virtual connection controller may translate the control command on the respective PLC or control system into specific software and/or hardware instructions. In another embodiment, the user device communicates the control command directly to the respective PLC or control system without going through an intermediary application. For example, an end-to-end connection may be established between a user device and a PLC or control system on the drilling management network.

In Block 555, programmable logic controller data regarding one or more programmable logic controllers are transmitted to a user device in accordance with one or more embodiments. In one or more embodiments, for example, a graphical user interface is provided on a user device that presents PLC data regarding a programmable logic controller or control system. In particular, a historian may be located on a drilling management network that stores past drilling management data, e.g., sensor measurements, quality control data, system failures, etc., collected about various PLCs and control systems on the drilling management network. On the graphical user interface, the PLC data may be presented as raw data and/or transformed data using various historical analyses of the raw data. For example, if a user requests access to the progress of a drilling operation with a particular drill bit over the past week, corresponding PLC data for the drill bit may be shown in the graphical user interface.

In one or more embodiments, a virtual connection controller on a user networks obtains the PLC data directly from PLCs and control systems on the drilling management network. Accordingly, the virtual connection controller may relay a portion of the PLC data to the user device. Likewise, the virtual connection controller may transform the PLC data into a different format before relaying the PLC data to the user device.

While Block 555 is shown occurring while the virtual connection is established in Block 545 and before the virtual connection is terminated in Block 570, in one or more embodiments, PLC data is transmitted without using a virtual connection. For example, one or more network links may exist between a drilling management network and a user network that provide for transmission of PLC data from PLCs on the drilling management network to the user network. However, these network links may include functionality that prevents control commands from being sent across the network links.

In Block 560, a determination is made whether an ending time is reached for a virtual connection in accordance with one or more embodiments. In one or more embodiments, for example, a virtual connection controller monitors a clock for whether the virtual connection established in Block 545 is outside a particular time window. Once the time window has expired, the virtual connection controller may terminate the virtual connection in a similar manner as discussed above with respect to Block 330 in FIG. 3 and the accompanying description. Likewise, if a user device transmits a request to terminate the virtual connection, the ending time may be determined to be reached. When a determination is made that the ending time is reached, the process may proceed to Block 570. When a determination is made that the ending time is not reached, the process may return to Block 550.

In Block 570, a virtual connection is terminated in accordance with one or more embodiments. In one or more embodiments, upon detecting the ending time of the virtual connection, the user device code from Block 535 is disabled. Accordingly, a virtual connection controller may terminate the virtual connection is a similar manner as described in Block 330 of FIG. 3 and the accompanying description.

In Block 575, a jump host is powered off in accordance with one or more embodiment. For example, a jump host or a virtual connection controller on a user network may detect that no remaining virtual connections exist to the drilling management network, and the jump host may automatically shut down accordingly. While shutdown, the jump host may not be compromised by security breaches on the user network.

Accordingly, as shown in the processes described in FIGS. 3 and 5 above, automation of establishing and terminating virtual connections may be transparent and with minimal human intervention. In particular, ad-hoc maintenance may be performed with minimal rig personnel involvement (e.g. to approve various time windows in various user accounts). Moreover, drilling operation and maintenance workflow may be consistent without respect to whether a user device is connected onsite or in a remote location. Likewise, the techniques discussed in FIGS. 3 and 5 may remove various manual connections to the drilling management network that depend on rig operations and human personnel availability. Likewise, manual connections may be forgotten and mismanaged, resulting in various security risks to the drilling management network.

In one or more embodiments, the techniques described in FIGS. 3 and 4 and the accompanying description remove manual intervention by users for connecting user devices to PLCs on a drilling management network. In a well construction system, for example, various control systems may be locally managed. Because a security breach to the control system may carry various risks to operation safety, equipment, personnel safety, and/or environmental safety, securing drilling operation control systems and/or maintenance control systems may present a challenge. Accordingly, additional tasks like inspecting network traffic to a drilling management network may not be an option. Moreover, various security measures may rely on passive monitoring. Thus, maintenance work is often performed locally due to the risks involved with providing remote access. Therefore, the above discussed techniques may automate local and remote connections of user devices with physically connecting and disconnecting connections between a drilling management network and a different network.

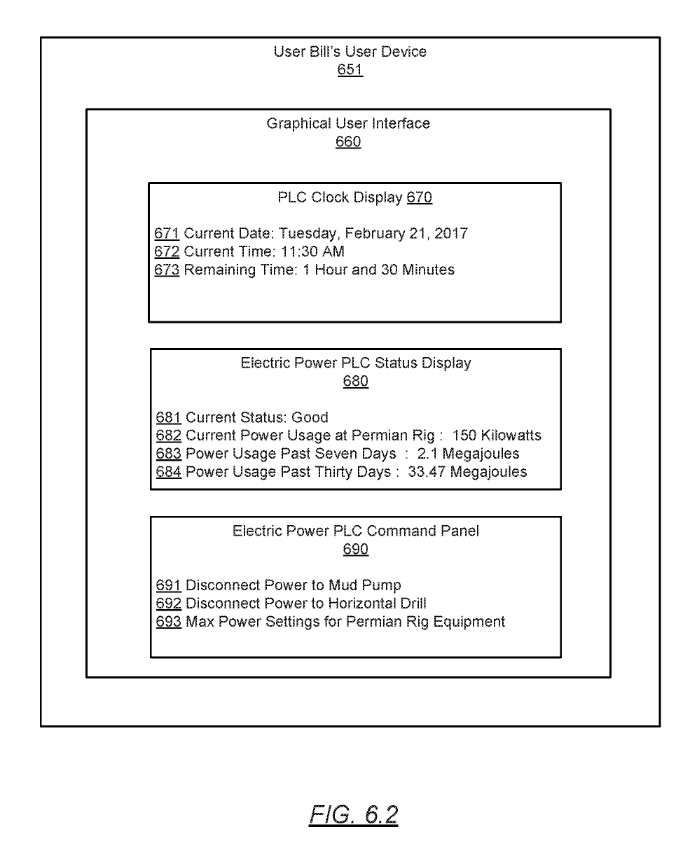

Turning to FIGS. 6.1 and 6.2, FIGS. 6.1 and 6.2 provide an example of establishing a virtual connection for accessing a control system on a drilling management network. The following example is for explanatory purposes only and not intended to limit the scope of the disclosure.

Turning to FIG. 6.1, a Drilling Rig controller (610) is shown acting as a virtual connection controller in this example. In particular, the Drilling Rig controller (610) identifies the current date and time based on data stored in a current time attribute (601). Moreover, the Drilling Rig controller (610) receives various pending requests (e.g., User Joe's Request to Access Fuel Control PLC (621), User Bill's Request to Access Electric Power PLC (622), and User Kathy's Request to Access Mud Treatment PLC (623)) to access various programmable logic controllers located on a network around the Drilling Rig.

Keeping with FIG. 6.1, the Drilling Rig controller (610) analyzes User Joe's Request (621) using a PLC authorization function (641) to determine whether to deny or grant User Joe's Request (621) for accessing a fuel control PLC (615). The PLC authorization function (641) may correspond to one or more blocks described in FIGS. 3 and 5 and the accompanying description. First, the Drilling Rig controller (610) obtains information from User Joe's Account (624) located on a user network (not shown) around the Drilling Rig. In particular, based on data stored in User Joe's Account (624), User Joe has permission attributes (603) designated him authorization for accessing a Mud Pump PLC (611), a drilling control PLC (612), and a mud treatment PLC (613). Likewise, based on data stored in User Joe's Account (624), User Joe has time window attributes (604) that specify a general time window (631) for accessing PLCs on each Tuesday from 9:00 AM to 12:00 PM and another general time window (632) for accessing PLCs on each Thursday from 2:00 PM to 5:00 PM. After analyzing information from User Joe's Account (624), the Drilling Rig controller (610) determines that User Joe lacks authorization for accessing the fuel control PLC (615) on the Drilling Rig. Accordingly, User Joe's Request (621) is denied and no virtual connection is established.

Furthermore, as shown in FIG. 6.1, the Drilling Rig controller (610) analyzes User Bill's Request (622) using a PLC authorization function (641) to determine whether to deny or grant User Bill's Request (622) for accessing an electric power PLC (614). First, the Drilling Rig controller (610) obtains information from User Bill's Account (625) located on the user network around the Drilling Rig. In particular, based on data stored in User Bill's Account (625), User Bill has permission attributes (603) designated him authorization for accessing the electric power PLC (614) and the fuel control PLC (615). Likewise, based on User Bill's Account (625), User Bill has time window attributes (604) that specify a special time window (633) for accessing the electric power PLC (614) on each Tuesday from 11:00 AM to 1:00 PM and another special time window (634) for accessing the fuel control PLC (615) on each Thursday from 8:00 AM to 5:00 PM. After analyzing information from User Bill's Account (625), the Drilling Rig controller (610) determines that User Bill is authorized to access the electric power PLC (614) on the current date and time on the Drilling Rig. Accordingly, User Bill's Request (622) is granted and a virtual connection is established by the Drilling Rig controller (610) that allows User Bill's user device (651) to access the electric power PLC (615).

Keeping with FIG. 6.1, the Drilling Rig controller (610) analyzes User Kathy's Request (623) using a PLC authorization function (641) to determine whether to deny or grant User Kathy's Request (623) for accessing a mud treatment PLC (613). First, the Drilling Rig controller (610) obtains information from User Kathy's Account (626) located on the user network. In particular, based on data stored in User Kathy's Account (626), User Kathy has permission attributes (603) designated her authorization for accessing a Mud Pump PLC (611) and a mud treatment PLC (613). Likewise, based on data stored in User Kathy's Account (626), User Kathy has time window attributes (604) that specify a general time window (635) for accessing PLCs on each Monday from 10:00 AM to 1:00 PM and another general time window (636) for accessing PLCs on each Wednesday from 2:00 PM to 5:00 PM. After analyzing information from User Kathy's Account (626), the Drilling Rig controller (610) determines that User Kathy is authorized for accessing the mud treatment PLC (613) on the Drilling Rig, but User Kathy's Request (623) is outside both general time windows (635, 636) for her user account (626). Accordingly, User Kathy's Request (623) is denied and no virtual connection is established.

Turning to FIG. 6.2, FIG. 6.2 shows a graphical user interface (660) operating on User Bill's user device (651). While a virtual connection is established to a drilling management network on the Drilling Rig, a jump host on the user network may forward PLC data from electric power PLC (614) to User Bill's user device (651), which is presented in the electric power PLC status display (680). In particular, various status attributes are shown, such as the current status (681) of the electric power PLC (614), the current power usage (682) at the Drilling Rig, power usage for the past seven days (683), and power usage for the past thirty days (684). Moreover, the graphical user interface (660) provides an electric power PLC command panel (690). Using the electric power PLC command panel (690), User Bill may transmit one or more control commands to the jump host for controlling the electric power PLC (614). For example, control commands may include disconnecting power to a mud pump (691), disconnecting power to a drill (692), and adjusting maximum power settings for various Drilling Rig equipment (693). Furthermore, the graphical user interface (660) also includes a PLC clock display (670) that shows the current date (671) and current time (672) to User Bill. Likewise, Drilling Rig controller (610) has computed the remaining time (673) within User Bill's general time window (631) and presented the remaining time (673) within the PLC clock display (670).

Embodiments may be implemented on a computing system. Any combination of mobile, desktop, server, router, switch, embedded device, or other types of hardware may be used. For example, as shown in FIG. 7.1, the computing system (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), and numerous other elements and functionalities.

The computer processor(s) (702) may be an integrated circuit for processing instructions. For example, the computer processor(s) may be one or more cores or micro-cores of a processor. The computing system (700) may also include one or more input devices (710), such as a touchscreen, keyboard, mouse, microphone, touchpad, electronic pen, or any other type of input device.

The communication interface (712) may include an integrated circuit for connecting the computing system (700) to a network (not shown) (e.g., a local area network (LAN), a wide area network (WAN) such as the Internet, mobile network, or any other type of network) and/or to another device, such as another computing device.

Further, the computing system (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (700) in FIG. 7.1 may be connected to or be a part of a network. For example, as shown in FIG. 7.2, the network (720) may include multiple nodes (e.g., node X (722), node Y (724)). Each node may correspond to a computing system, such as the computing system shown in FIG. 7.1, or a group of nodes combined may correspond to the computing system shown in FIG. 7.1. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (700) may be located at a remote location and connected to the other elements over a network.

Although not shown in FIG. 7.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (722), node Y (724)) in the network (720) may be configured to provide services for a client device (726). For example, the nodes may be part of a cloud computing system. The nodes may include functionality to receive requests from the client device (726) and transmit responses to the client device (726). The client device (726) may be a computing system, such as the computing system shown in FIG. 7.1. Further, the client device (726) may include and/or perform all or a portion of one or more embodiments of the disclosure.

The computing system or group of computing systems described in FIGS.

7.1 and 7.2 may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system (700) in FIG. 7.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 7.1, while performing one or more embodiments of the disclosure, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 7.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the

DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 7.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 7.1 and the nodes and/or client device in FIG. 7.2. Other functions may be performed using one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method, comprising:
obtaining, at a network element on a user network and from a user device, a request to access a first programmable logic controller (PLC) located in a drilling management network;
determining, at the network element, whether the user device is authorized for accessing the first PLC based at least in part on user access credentials associated with the user device;
establishing, in response to determining that the user device is authorized, a virtual connection between the user network and the drilling management network; and
terminating the virtual connection.

2. The method of claim 1,
wherein the virtual connection is established using a switched virtual connection located between the drilling management network and the user network, and
wherein the switched virtual connection is a physical link configured to become a data link layer connection between adjacent network nodes in response to determining that the user device is authorized.

3. The method of claim 1,
wherein the virtual connection is established using a virtual connection controller located on the user network, and
wherein the virtual connection controller is a jump host that manages the drilling management network as a separate security zone from the user network.

4. The method of claim 1, further comprising:
accessing a user account associated with the user device; and
determining, based at least in part on data from the user account, a time window that the user device is authorized to access a second PLC located in the drilling management network,
wherein the virtual connection is established at a starting time of the time window, and
wherein the virtual connection is terminated at an ending time of the time window.

5. The method of claim 1, further comprising:
generating a user device code in response to determining that the user device is authorized to access the first PLC; and
transmitting the user device code to the user device,
wherein the user device is configured to communicate with the first PLC using the user device code.

6. The method of claim 1, further comprising:
obtaining a control command from the user device while the virtual connection is established between the drilling management network and the user network, wherein the control command adjusts one or more settings on the first PLC; and
transmitting, from the drilling management network, PLC data to the user network while the virtual connection is terminated.

7. The method of claim 1, further comprising:
obtaining, from the user device, user credentials associated with a user account;
establishing, based at least in part on the user credentials and using a remote display protocol, a network connection between the user device and the network element on the user network.

8. The method of claim 1, further comprising:
transmitting, from the first PLC to the user device, PLC data while the virtual connection is established between the drilling management network and the user network,
wherein the PLC data describes one or more sensor values on the first PLC.

9. The method of claim 1,
wherein the virtual connection provides a logical path between the first PLC and the user device, and
wherein terminating the virtual connection comprises terminating the logical path.

10. The method of claim 1,
wherein the drilling management network comprises a plurality of network elements configured to control one or more drilling operations on a drilling rig.

11. The method of claim 1,
wherein the user network comprises a plurality of network elements configured to provide one or more user services on a drilling rig, and
wherein the one or more user services comprises Internet access for a computer device connected to the user network.

12. A system, comprising:
a drilling management network comprising a first programmable logic controller (PLC);
a user network coupled to the drilling management network, the user network comprising a plurality of network elements; and
a virtual connection controller operating on at least one network element of the plurality of network elements, wherein the virtual connection controller is configured to:
obtain, from a user device, a request to access the first PLC;
determine whether the user device is authorized for accessing the first PLC based at least in part on user access credentials associated with the user device;
establish, in response to determining that the user device is authorized, a virtual connection between the user network and the drilling management network; and
terminate the virtual connection.

13. The system of claim 12, further comprising:
a switched virtual connection disposed between the drilling management network and the user network, and
wherein the switched virtual connection is a physical link configured to become a data link layer connection between adjacent network nodes in response to determining that the user device is authorized.

14. The system of claim 12,
wherein the virtual connection controller is a jump host that manages the drilling management network as a separate security zone from the user network.

15. The system of claim 12, wherein the virtual connection controller is further configured to:
access a user account associated with the user device; and
determine, based at least in part on data from the user account, a time window that the user device is authorized to access a second PLC located in the drilling management network,
wherein the virtual connection is established at a starting time of the time window, and
wherein the virtual connection is terminated at an ending time of the time window.

16. The system of claim 12, wherein the virtual connection controller is further configured to:
generate a user device code in response to determining that the user device is authorized to access the first PLC; and
transmit the user device code to the user device,
wherein the user device is configured to communicate with the first PLC using the user device code.

17. The system of claim 12,
wherein the drilling management network is configured to only obtain a control command from the user network while the virtual connection is established between the drilling management network and the user network,
wherein the control command is configured to adjust one or more settings on the first PLC, and
wherein the drilling management network is further configured to transmit PLC data outside the drilling management network while the virtual connection is terminated and while the virtual connection is established.

18. A non-transitory computer readable medium storing instructions, the instructions comprising functionality for:
obtaining, at a network element on a user network and from a user device, a request to access a first programmable logic controller (PLC) located in a drilling management network;
determining, at the network element, whether the user device is authorized for accessing the first PLC based at least in part on user access credentials associated with the user device;
establishing, in response to determining that the user device is authorized, a virtual connection between the user network and the drilling management network; and
terminating the virtual connection.

19. The non-transitory computer readable medium of claim 18, wherein the instructions further comprise functionality for:
accessing a user account associated with the user device; and
determining, based at least in part on data from the user account, a time window that the user device is authorized to access a second PLC located in the drilling management network,
wherein the virtual connection is established at a starting time of the time window, and
wherein the virtual connection is terminated at an ending time of the time window.

20. The non-transitory computer readable medium of claim 19, wherein the instructions further comprise functionality for:
obtaining a control command from the user device while the virtual connection is established between the drilling management network and the user network, wherein the control command adjusts one or more settings on the first PLC; and
transmitting, from the drilling management network, PLC data to the user network while the virtual connection is terminated.
